(19) United States
(12) Patent Application Publication
(10) Pub. No.: US 2008/0213035 A1
(43) Pub. Date: Sep. 4, 2008

(54) Joint and/or Bearing Arrangement

(76) Inventor: Frank Scheper, Loningen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/916,060

(22) PCT Filed: May 31, 2006
(86) PCT No.: PCT/DE06/00935

§ 371 Date: Nov. 30, 2007

(30) Foreign Application Priority Data
Jun. 1, 2005 (DE) 10 2005 025 551.5

(51) Int. Cl. F16C 11/06; B60G 7/00

(52) U.S. Cl. 403/127

(57) ABSTRACT

A joint and/or bearing arrangement (1; 101; 201; 301; 401) with a joint or bearing body, which includes a joint pivot (2; 102; 202; 302; 402) and which can be held in a fixed manner in a mounting opening (6), for example, a pressing-in opening of a suspension arm (7), and has for this purpose at least one section (8) tapering in the direction of the pivot end (9) for support at least in some areas on a ring body (10; 10a; 110; 210; 310), especially a conical disk. The tapering section is joined towards the pivot end (9) by a parallel-walled or more weakly tapering area (11). A transition (14) is provided between the tapering section supported on the ring body (10; 10a; 110; 210; 310) and the section (11) that tapers more weakly towards the pivot end (9) or is cylindrical. The transition (14) is located outside the axial extension of the ring body (10; 10a; 110; 210; 310).

### CROSS REFERENCE TO RELATED APPLICATIONS

This application is a United States National Phase application of International Application PCT/DE2006/000935 and claims the benefit of priority under 35 U.S.C. §119 of German Patent Application DE 10 2005 025 551.5 filed Jun. 1, 2005, the entire contents of which are incorporated herein by reference.

### FIELD OF THE INVENTION

The present invention pertains to a joint and/or bearing arrangement as well as to a motor vehicle with one or more such joint and/or bearing arrangement(s), especially in chassis and/or steering parts.

### BACKGROUND OF THE INVENTION

In joint arrangements that have a fixed pivot consisting of, for example, steel, which is to be held, for example, in wheel carriers, suspension arms or other similar carriers consisting of a softer material, for example, an iron or aluminum casting, which have a mounting opening, it is difficult to achieve a stable and low-tolerance connection of the pivot in the mounting opening without excessively stressing the softer material. It is known that a fixed sleeve can be pressed into the carrier for this purpose. However, this has the drawback that strong forces act on the material surrounding the mounting opening during this pressing in, and these forces may lead to a widening of the mounting opening and, since frequently only a few mm of material are available there, they may excessively weaken the carrier.

Furthermore, it is known that a conical disk can be pressed onto the pivot. The pivot has a parallel-walled section for this, onto which the conical disk is pressed such that a conical section of the pivot can be braced in relation to an oblique surface of the conical disk by an axial pull. The oblique contact surface of the pivot, which is effective for the force transmission to the conical disk, is very small, and, moreover, a weakening arises at the transition from the conical pivot section to the axial section, especially when bending stress develops.

### SUMMARY OF THE INVENTION

The basic object of the present invention is to achieve an improvement of the holding of the pivot in the mounting opening.

According to the present invention the pivot pin remains free from a weak point in the area of the force transmission and it is also unnecessary to press a sleeve into the mounting opening. The carrier surrounding this opening is therefore stressed only minimally and may be very thin and formed from a relatively soft and lightweight material, for example, also from a light alloy casting. The ring body does not have to be pressed onto the pivot.

Nevertheless, the tapering area may have, at least in a part of its axial extension, a slope angle of 15° to 20° relative to the axis of the pivot and may also make possible a high axial prestress.

Nevertheless, pressing of the ring body onto the pivot or an intimate, self-locking connection is possible when the tapering area is stepped and an axially parallel, cylindrical section or a section of a smaller slope is formed in its direction facing away from the end of the pivot. As a result, the area of the pivot supported on the ring body, especially a conical disk, can nevertheless perform, unaffected, a maximum force transmission to the conical disk. A step on the side facing away from the end of the pivot is thus harmless.

When the tapering area has a variable slope decreasing towards the end of the pivot, especially good supporting can be ensured against bending stress while the axial prestress is high at the same time. The slope may pass over into a cylindrical area that adjoins the end of the pivot and has, for example, parallel walls, without a kink.

Only low requirements are to be imposed on the outer contour of the open or closed ring body. This ring body does not need to be pressed into the carrier of the mounting opening but it may also be held, for example, by bonding or other measures. As a result, different external shapes and outer contour of the ring body are possible as well. For example, this contour may also be parabolic, hyperbolic, conical or truncated cone-shaped.

If the ring body consists of a material that has, e.g., the same strength as the joint pivot, the risk of plastic deformation of one of the two parts is prevented. The acting forces and stresses can be distributed uniformly between these.

Such joint or bearing arrangements can be subjected with the axial prestress both axially and also intensely to bending because of the large two-dimensional support.

For axial prestressing, the pivot may have a thread at the pivot end and can be prestressed in a defined manner by means of a corresponding nut.

A joint arrangement according to the present invention can thus also be used on highly stressed and yet weight-optimized brackets of parts having a greater strength in mounting openings of softer parts, for example, within chassis and/or steering parts of motor vehicles, for example, in the support of parts of the wheel suspension.

Other advantages and features of the present invention appear from exemplary embodiments of the subject of the present invention, which are shown in the drawings and will be described below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic general drawing of a joint and/or bearing arrangement according to the present invention with a pivot held in a suspension arm and with a pivot end pointing upward;

FIG. 2 is a detail view, corresponding to detail II in FIG. 1;

FIG. 3 is a view similar to that in FIG. 2 before the mounting of the joint shell and sealing and additionally with a step in the conical section of the pivot on its side facing away from the end of the pivot;

FIG. 4 is a view of the detail IV in FIG. 3;

FIG. 5 is a view similar to that in FIG. 3, but with a continuous slope in the conical area of the pivot and with a conical disk projecting over this area towards the end of the pivot;

FIG. 6 is a view similar to that in FIG. 5, but with concave design of the section supported in the conical disk;

FIG. 7 is a view similar to that in FIG. 6, but with convex design of the section supported in the conical disk; and

FIG. 8 is a view similar to that in FIG. 2, but with a slope that is greater towards the end of the pivot in the transition to the narrower section.

### DESCRIPTION OF THE PREFERRED EMBODIMENTS

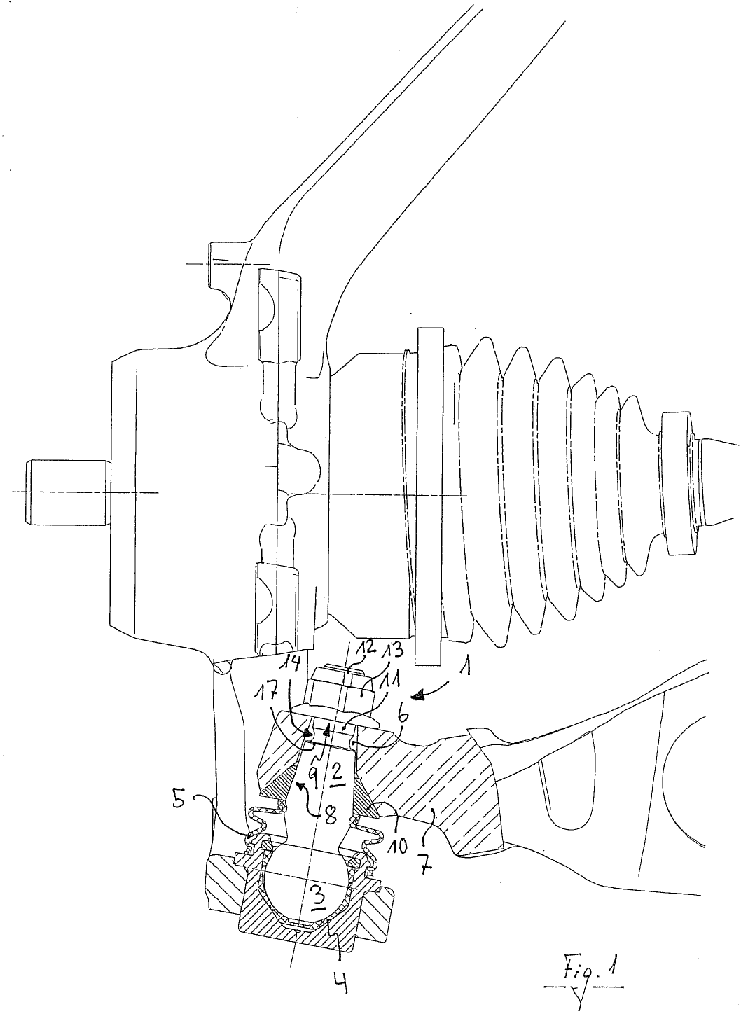

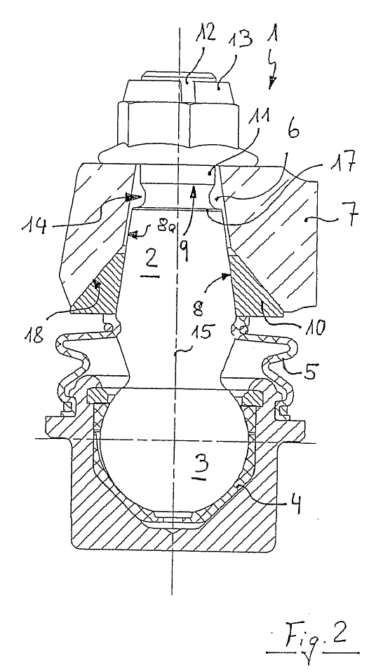

Referring to the drawings in particular, the joint arrangement 1 shown in the first exemplary embodiment according to FIGS. 1 and 2 comprises an axially extended joint body 2, which is, on the whole, of a pivot-like design here, with a joint head 3 formed, for example, by an essentially spherical bulge. This joint head can be held movably in a—frequently slit—joint shell 4, An additional sealing 5 for the contact area between the joint head 3 and the joint shell 4 may be provided to avoid external contamination and to hold a lubricant reservoir.

Joint and/or bearing arrangements 1, 101, 201, 301, 401 according to the present invention may, however, have a great variety of designs. In any case, they comprise a design of the joint or bearing body 2, 102, 202, 302, 402, which is pivot-shaped at least in some areas and which can be held in a fixed manner in a mounting opening, here a press-in opening 6 of a suspension arm 7, for establishing a connection between an opening 6 in a relatively soft material and a body 2 having a greater strength. The suspension arm 7 consists, for example, of a relatively soft cast or forged aluminum, magnesium or iron material and may have only little material around the opening 6, for example, with a thickness of only 2 to 5 mm, in order to thus keep the dimension and the weight of the assembly unit as low as possible.

Such a joint arrangement 1, 10 1, 201, 301, 401 may be pressed in axially with a press fit. The joint may be manufactured with diameter tolerances in the range of a few hundredths of one mm, and so may the internal dimension of the opening 6 of the receiving body 7.

For being firmly supported in the opening 6 of the part, which is especially a chassis or steering part 7, the joint body 2 according to FIG. 2 comprises a section 8 tapering in the direction of the pivot end 9 located opposite the joint head 3. Via this section 8, the joint body 2 is supported indirectly in relation to the opening 6. Since the joint body 2 may be considerably harder than the material surrounding the opening 6, and it may consist, for example, of a chromium-molybdenum steel, an open or closed ring body 10, especially a conical disk, which is in contact with both the edge of the opening 6 and the tapering section 8, is inserted between this and the opening 6. The ring body 10 consists of a material that has approximately the same strength as the joint pivot 2.

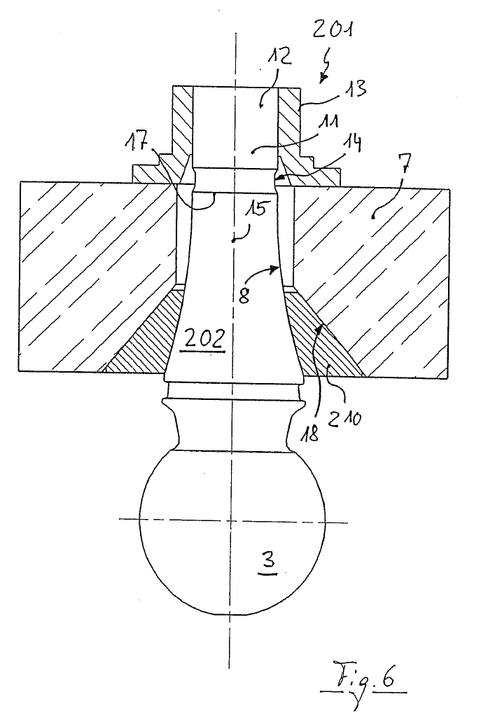

As is apparent from FIG. 5, the conical disk 10a may project beyond the area 8 supported at the conical disk 10a in the direction of the pivot end 9 or, as is shown in FIG. 1, it may be located completely above its end 17 facing the pivot end 9. In both cases, the supported conical area 8 is in contact with the inner walls of the opening 6 via the conical disk 10, 10a only.

Towards the pivot end 9, the end 17 of the tapering section 8 may be joined by a narrower and at least partially parallel and hence cylindrical or slightly tapering area 11, which has a sufficiently small diameter to pass through the opening 6 even at its narrowest point and to open into a thread 12 for cooperating with a nut 13 or with another tightening element. The pivot 2 can be axially prestressed hereby. Such a joint and/or bearing arrangement 1 can counteract both radial loads, e.g., in guiding joints, and axial and radial loads, for example, in support joints.

The largest possible contact area is necessary between the tapering area 8 and the ring body 10 for high loads.

A transition 14 is located for this purpose according to the present invention between the tapering section 8 supported at the ring body and the thinner section 11 adjoining the pivot end 9 outside the axial extension of the ring body 10 in the direction of the pivot end 9. As a result, the ring body 10 can have full contact here (see FIG. 2) with the tapering section 8, so that a large force introduction area is formed, which is not weakened by a kink or another similar transition 14, because this transition 14 is located outside the contact area between the ring body 10 and the supported tapering section 8 of the pivot 2.

It becomes clear in the joint arrangement 401 according to FIG. 8 that a greater slope may also be present at the transition 14 from the supported area 8 to the narrower area 11 of the pivot 402, so that the area 11 does not have to taper, on the whole, more weakly than the supported area 8.

The tapering area 8 supported at the ring body 10 in the mounted position has a slope angle that is uniform here in relation to the axis 15 of the pivot 2, equaling 15° to 20°, in a part 8a, which assumes the entire axial extension of the area 8 in the first exemplary embodiment according to FIG. 1 and FIG. 2. The slope of area 8 is therefore uniformly linear in the first exemplary embodiment, which is not compulsory, as will be explained in further exemplary embodiments.

The smaller the slope angle of area 8, the sooner is also the pressing on of the ring body 10, designed as a conical disk here, made possible, without this ring body 10 being able to slip off from the pivot 2.

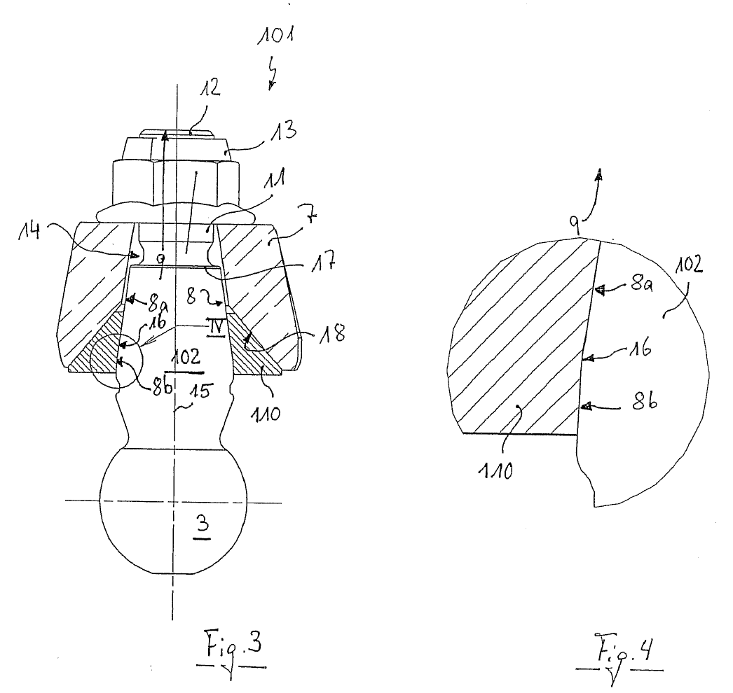

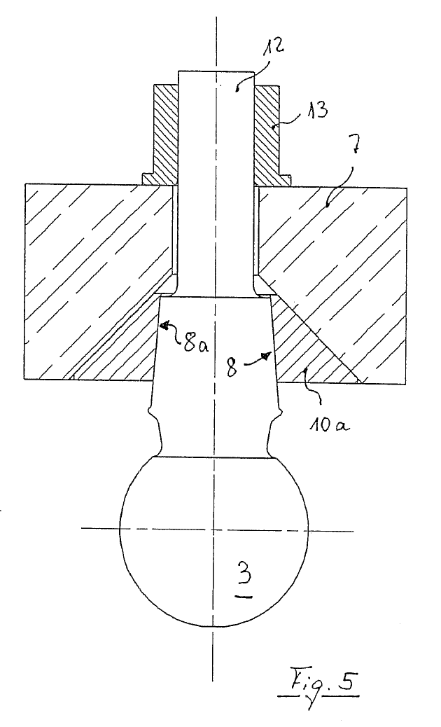

Provisions are made herefor for the joint arrangement 101 according to the second exemplary embodiment according to FIGS. 3 and 4 that for an intimate, self-locking connection to the conical disk 110, the area 8 of the pivot 102, which is supported thereon, is stepped 16 into a section 8a braced axially with the conical disk and an axially parallel section or section 8b of a smaller slope in its direction facing away from the pivot end 9. As a result, the area 8a of the pivot 2, which is supported on the ring body 10, especially a conical disk, can nevertheless perform, unaffected, a maximum transmission of force to the conical disk 10. By contrast, the ring body 10 can be pressed onto the area 8b. A step 16 on the side of the area 8 facing away from the pivot end 9 is harmless for the supporting of the area 8a facing the pivot end 9.

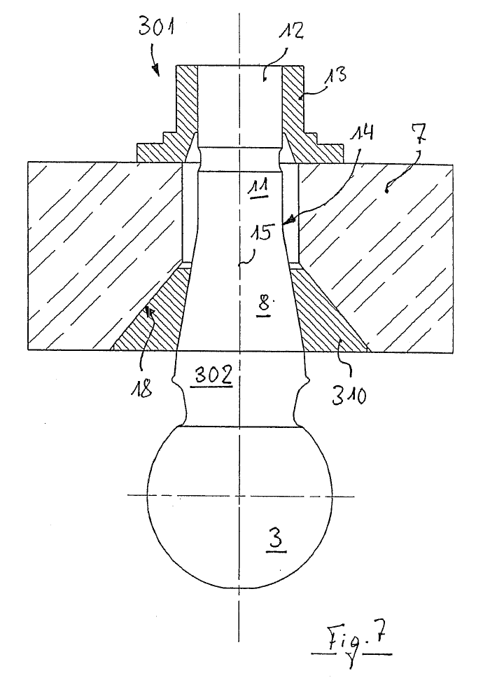

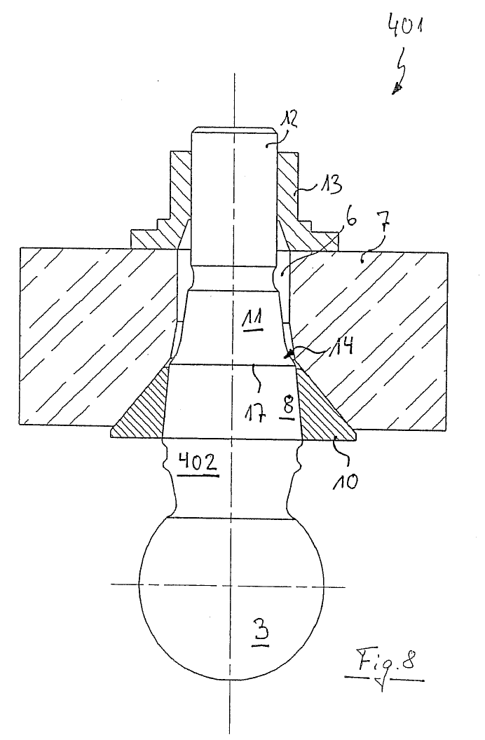

In addition or as an alternative to the step 16, the tapering area 8 may also have a variable slope decreasing towards the pivot end 9 according to FIG. 6 or a slope increasing towards the pivot end 9 according to FIG. 7.

In the concave embodiment of the joint or bearing arrangement 202 according to FIG. 6, the area 8 can pass over into the narrower area 11 adjoining the pivot end 9 without a kink or another weakening. The groove shown here is due merely to the manufacturing technology and is, moreover, located axially far outside the supported section 8. The inner contour of the ring body 210, which contour faces the outer wall of the joint pivot 202, is provided, in adaptation to the supported tapering area 8 of the joint pivot 202, with a convex design complementary to the joint pivot 202.

The conditions are exactly the opposite in the embodiment according to FIG. 7: The pivot 302 of the joint or bearing arrangement 301 is provided here with a convex section 8, and the inner wall of the ring body 310 is correspondingly of a concave design in adaptation hereto.

In any case, there must be a sufficiently great slope at least in a partial area of section 8 in order to make it possible to achieve an axial prestressing via the tightening element 13.

The shape of section 8 may therefore be, on the whole, both hyperbolic and parabolic, with or without steps, or another shape is possible as well, but a pivot end-side transition 14 to the further, narrower section 11 is always located outside the supported area 8 at the ring body 10, 110, 210, 310.

The connection between the supported area 8 and the ring body 10, 110, 210, 310 may have various designs; besides pressing on, a bonding may, for example, be possible as well. The connection may also be brought about by sealing 5 alone in case of a mere contact.

The outer contour of the ring body 10, 10a, 110, 210, 310 facing the inner wall of the mounting opening 6 may also have a different shape and be, for example, parabolic, hyperbolic or conical.

The ring body 10, 10a, 110, 210, 310 does not always have to have a rotationally symmetrical design with the pivot axis, but it may also be elliptical or elongated in another manner in the opposite direction in case of a bending stress on the joint or bearing arrangement with a preferential direction of force, e.g., in only one plane in case of a steadily recurring bending, for example, against this stress. The pivot 2, 102, 202, 302, 402 itself may now also have an adapted, for example, elliptical cross section.

Various designs of the outer surfaces 18 of the conical disk 10, 10a, 110, 210, 310, which are directly in contact with the softer component 7, are conceivable as well, and there should be an axial and radial support depending on the requirements. Moreover, a large contact area is helpful here as well in order to avoid excessive punctiform loads on the relatively soft component 7 and to avoid the risk for plastic deformations.

While specific embodiments of the invention have been shown and described in detail to illustrate the application of the principles of the invention, it will be understood that the invention may be embodied otherwise without departing from such principles.

In the claims:

1. A joint and/or bearing arrangement (1; 101; 201; 301; 401) comprising;
a joint or bearing body, comprising a joint pivot for being fixed in a mounting opening, or a pressing-in opening of a suspension arm, said joint pivot having a pivot end, an area and a tapering section tapering in the direction of said pivot end,
a ring body, said tapering section for supporting said ring body at least in some areas said section being joined towards said pivot end by [[a]] said area, said area being cylindrical or tapering less compared to said tapering section, said pivot having a transition located between said tapering section and said area said transition being outside an axial extension of said ring body.

2. A joint and/or bearing arrangement in accordance with claim 1, wherein said joint pivot is formed from a material that has a greater strength than the material surrounding said mounting opening.

3. A joint and/or bearing arrangement in accordance with claim 1, wherein said tapering section has a slope angle of 15° to 20° relative to an axis of said pivot at least in one part of an axial extension thereof.

4. A joint and/or bearing arrangement in accordance with claim 1, wherein said tapering section is stepped and has a cylindrical section or said tapering section has a comparatively smaller slope in its direction facing away from said pivot end.

5. A joint and/or bearing arrangement in accordance with claim 1, wherein said tapering section has a variable slope decreasing or increasing towards said pivot end.

6. A joint and/or bearing arrangement in accordance with claim 1, wherein said supporting ring body is in contact with both an inner wall of said mounting opening and an outer wall of said pivot pin.

7. A joint and/or bearing arrangement in accordance with claim 6, wherein the outer contour of said ring body facing the outer wall of said joint pivot has an essentially conical design with a slope angle complementary to said joint pivot in a supported region of said tapering section in adaptation to said supported region of said tapering section of said joint pivot.

8. A joint and/or bearing arrangement in accordance with claim 6, wherein the inner contour of said ring body facing said joint pivot is parabolic, hyperbolic or conical.

9. A joint and/or bearing arrangement in accordance with claim 1, wherein said ring body consists of a material having approximately the same strength as said joint pivot.

10. A joint and/or bearing arrangement in accordance with claim 1, wherein this joint and/or bearing arrangement can be stressed both axially and radially for bending.

11. A joint and/or bearing arrangement in accordance with claim 1, wherein said ring body has a longitudinal extension deviating from the symmetry of rotation for counteraction against a preferential direction of the stress.

12. A joint and/or bearing arrangement in accordance with claim 1, wherein said mounting opening is recessed from a suspension arm or carrier made of a casting.

13. A joint and/or bearing arrangement in accordance with claim 1, wherein said pivot can be axially prestressed via a thread associated with said pivot end and a tightening element.

14. A motor vehicle comprising:
chassis and/or steering parts including a suspension arm; and a joint or bearing body comprising a joint pivot fixed in a mounting opening or a pressing-in opening of said suspension arm, said joint pivot having a pivot end, an area and a section tapering in the direction of said pivot end and a ring body, said section for supporting said ring body at least in some areas, said section being joined towards said pivot end by said area, said area being cylindrical or tapering less compared to said section, said pivot having a transition located between said section and said area, said transition being outside an axial extension of said ring body.

15. A motor vehicle in accordance with claim 14, wherein said joint pivot is formed from a material that has a greater strength than the material surrounding said mounting opening and said tapering section has a slope angle of 15° to 20° relative to an axis of said pivot at least in one part of an axial extension thereof.

16. A motor vehicle in accordance with claim 14, wherein said tapering section is stepped and has a cylindrical section or said tapering section has a comparatively smaller slope in a direction facing away from said pivot end.

17. A motor vehicle in accordance with claim 14, wherein said tapering area has a variable slope decreasing or increasing towards said pivot end.

18. A motor vehicle in accordance with claim 14, wherein said supporting ring body is in contact with both an inner wall of said mounting opening and an outer wall of said pivot pin.

19. A motor vehicle in accordance with claim 18, wherein the outer contour of said ring body facing the outer wall of said joint pivot has an essentially conical design with a slope angle complementary to said joint pivot in a supported region of said tapering section in adaptation to said supported region of said tapering section of said joint pivot.

20. A motor vehicle in accordance with claim 14, wherein said ring body has a longitudinal extension deviating from the symmetry of rotation for counteraction against a preferential direction of the stress.
